(19) United States
(12) Patent Application Publication
(10) Pub. No.: US 2011/0046405 A1
(43) Pub. Date: Feb. 24, 2011

(54) METHOD FOR THE AQUEOUS TREATMENT OF AN AMINO-FUNCTIONAL ORGANOSILANE CONTAINING AMMONIUM HALIDES AND/OR ORGANIC AMINE HYDROHALIDES

(75) Inventors: Philipp Albert, Loerrach (DE); Eckhard Just, Rheinfelden (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik Degussa GmbH, Essen (DE)

(21) Appl. No.: 12/988,637

(22) PCT Filed: Apr. 9, 2009
(86) PCT No.: PCT/EP2009/054282

§ 371 Date: Oct. 20, 2010

(30) Foreign Application Priority Data
Jun. 3, 2008 (DE) 102008002181.4

(51) Int. Cl. C07F 7/10

(52) U.S. Cl. 556/423

(57) ABSTRACT

The invention relates to a method for the treatment of an amino functional organosilane containing ammonium halides and/or organic amine hydrohalides, wherein at least one non-polar organic solvent is optionally added to the amino functional organosilane containing the ammonium halides and/or organic amine hydrohalides, an aqueous lye is added. The mixture is reacted and subsequently the aqueous phase is separated from the organic phase, the solvent contained in the organic phase is removed from said phase and the residual organic phase is recovered.

The present invention relates to a novel process for an aqueous workup of an amino-functional organosilane containing ammonium halides and/or organic amine hydrohalides, as obtained for example in the preparation of an amino-functional organosilane by reacting a halogen-functional organosilane with excess ammonia or an organic amine.

Aminosilanes have a wide spectrum of application. They are used, for example, for glass fiber sizes or in the foundry industry as processing aids; they likewise serve as adhesion promoters for storage-stable resins.

It has long been known that amino-functional organosilanes can be prepared especially from chlorine-functional organosilanes and ammonia or organic amines; in this case, the ammonium chloride formed or the organic amine hydrochloride formed have to be removed (DE-C 10 23 462, DE-C 27 49 316, DE-C 27 53 124, EP 0 702 017 A2, EP 0 741 137 A2, EP 0 849 271 A2, EP 1 295 889 A2).

The procedure in EP 1 262 484 A2, EP 1 209 162 A2 and DE 101 40 563 A1 is to conduct the preparation process over various pressure stages, as a result of which, inter alia, the consequences from the problems of salt caking were reduced.

A common feature of the processes for preparing amino-functional organosilanes by reacting corresponding organohalo-functional silanes with ammonia or an amine is that salt-type compounds obtained therein, especially ammonium halides and/or organic amine hydrochlorides, can be separated substantially completely from the desired product only with a high level of cost and inconvenience, and the products nevertheless have an unwanted halide content. Furthermore, efforts are also made after the preparation process to once again reduce the residual content of halide in the amino-functional organosilane by additional complex aftertreatments, for example by titration of the product with an alcoholic alkali metal alkoxide solution, EP 0 702 017.

It was therefore an object of the present invention to find a further means of working up amino-functional organosilanes containing ammonium halides and/or organic amine hydrohalides.

The stated object is achieved in accordance with the invention according to the details in the claims.

It has been found that, surprisingly, ammonium halides and/or organic amine hydrohalides, especially hydrochlorides, can be removed from aminosilanes with addition of a strongly alkaline aqueous solution without hydrolyzing the aminoalkoxysilane.

Furthermore, this comparatively simple process achieves halide contents in the product of less than 100 ppm by weight.

The present process is generally applicable advantageously to all amino-functional organosilanes. More particularly, this advantageously enabled a comparatively simple and at the same time economic aqueous workup of crude product from an aminosilane synthesis.

It has thus been found, surprisingly, that an amino-functional organosilane containing ammonium halides and/or organic amine hydrohalides, the preparation being based on the reaction of a halogen-functional organoalkoxysilane with excess ammonia or organic amine, preferably under pressure and in the liquid phase, and subsequent separation and workup of crude product and salt obtained, can be worked up in a simple and economic manner by
optionally adding at least one nonpolar organic solvent to the amino-functional organosilane containing ammonium halides and/or organic amine hydrohalides (referred to here and hereinafter as crude product or product mixture),
adding an aqueous alkali,
allowing them to react, preferably for a defined period of time,
then separating the aqueous phase from the organic phase, and
removing the solvent(s) present from the organic phase
to obtain the remaining organic phase.

Furthermore, such an amino-functional organosilane obtained by the process according to the invention advantageously has a hydrolyzable chloride content of less than 100 ppm by weight down to the detection limit of 6 ppm by weight. Examples of hydrolyzable chloride include organic amine hydrochlorides, ammonium chlorides, chlorosilanes, etc. Hydrolyzable chloride can be determined, for example, potentiographically with silver nitrate.

According to the invention, it is especially possible to work up amino-functional organosilanes of the general formula (I), but also those of the general formula (II) and/or (III), or their respective crude products or corresponding product mixtures of organosilanes of the formulae (I), (II) and/or (III), as obtainable inter alia in the preparation:

unbridged amino-functional organosilanes, i.e. monosilylated amines, can be illustrated by the general formula (I):

R₂N[(CH₂)₂NH]_{z}(Z)Si(R″)ₙ(OR′)₃₋ₙ (I)
in which R groups are the same or different and R is hydrogen (H) or a linear or branched alkyl group having 1 to 4 carbon atoms, preferably H or n-butyl, R′ groups are the same or different and R′ is hydrogen (H) or a linear or branched alkyl group having 1 to 8 carbon atoms or an aryl group, preferably methyl or ethyl, R″ groups are the same or different and R″ is a linear or branched alkyl group having 1 to 8 carbon atoms, such as methyl, ethyl, propyl, butyl, preferably methyl, or an aryl group, Z is a bivalent alkyl group from the group of —CH₂—, —(CH₂)₂—, —(CH₂)₃—, —(CH₂)₄— or —(CH₂)(CH)CH₃(CH₂)—, preferably propyl, n is 0, 1, 2 or 3, preferably 0, and z is 0, 1 or 2,
   bis-amino-functional organosilanes, i.e. bis-silylated amines, by the general formula (II):

(R′O)₃₋ₙ(R″)ₙSi(Z)[NH(CH₂)₂]_{y}NR[(CH₂)₂NH]_{z}(Z)Si(R″)ₙ(OR′)₃₋ₙ (II)
in which R is a hydrogen (H) or a linear or branched alkyl group having 1 to 4 carbon atoms, preferably H or n-butyl, R′ groups are the same or different and R′ is hydrogen (H) or a linear or branched alkyl group having 1 to 8 carbon atoms or an aryl group, preferably methyl or ethyl, R″ groups are the same or different and R″ is a linear or branched alkyl group having 1 to 8 carbon atoms, such as methyl, ethyl, propyl, butyl, preferably methyl, or an aryl group, Z groups are the same or different and Z is a bivalent alkyl group from the group of —CH₂—, —(CH₂)₂—, —(CH₂)₃—, —(CH₂)₄— or —(CH₂)(CH)CH₃(CH₂)—, preferably propyl, n is independently 0, 1, 2 or 3, preferably 0, and y and z are each independently 0, 1 or 2,
   preferably
   (H₃CO)₃Si(CH₂)₃NH(CH₂)₃Si(OCH₃)₃ (bis-AMMO),
   (H₅C₂O)₃Si(CH₂)₃NH(CH₂)₃Si(OC₂H₅)₃ (bis-AMEO),
   and
   tris-amino-functional organosilanes, i.e. tris-silylated amines, by the general formula (III):

[(R′O)₃₋ₙ(R″)ₙSi(Z)[NH(CH₂)₂]ₓ]₃N (III)
in which R′ groups are the same or different and R′ is a hydrogen (H) or a linear or branched alkyl group having 1 to 8 carbon atoms or an aryl group, preferably methyl or ethyl, R″ groups are the same or different and R″ is a linear or branched alkyl group having 1 to 4 carbon atoms, such as methyl, ethyl, propyl, butyl, preferably methyl, or an aryl group, Z groups are the same or different and Z is a bivalent alkyl group from the group of —CH₂—, —(CH₂)₂—, —(CH₂)₃—, —(CH₂)₄— or —(CH₂)(CH)CH₃(CH₂)—, preferably propyl, n is independently 0, 1, 2 or 3, preferably 0, and X is independently 0, 1 or 2,
   preferably
   [(H₃CO)₃Si(CH₂)₃]₃N (tris-AMMO),
   [(H₅C₂O)₃Si(CH₂)₃]₃N (tris-AMEO).

The invention thus provides a process for working up an amino-functional organosilane containing ammonium halides and/or organic amine hydrohalides [also referred to as “aqueous workup” for short],

by
optionally adding at least one nonpolar organic solvent to the amino-functional organosilane containing ammonium halides and/or organic amine hydrohalides,
adding an aqueous alkali,
allowing them to react,
then separating the aqueous phase from the organic phase, and
removing any solvent present from the organic phase
to obtain the remaining organic phase.

In a preferred embodiment of the process according to the invention, the procedure is advantageously that
a halogen-functional organosilane of the general formula (IV)

X—Z—Si(R″)ₙ(OR)₃₋ₙ (IV)
in which X is Cl, Br or I, Z is a bivalent alkyl group from the group of —CH₂—, —(CH₂)₂—, —(CH₂)₃—, —(CH₂)₄— or —(CH₂)(CH)CH₃(CH₂)—, preferably propyl, R′ groups are the same or different and R′ is a hydrogen (H) or a linear or branched alkyl group having 1 to 8 carbon atoms or an aryl group, preferably methyl or ethyl, R″ groups are the same or different and R″ is a linear or branched alkyl group having 1 to 8 carbon atoms, such as methyl, ethyl, propyl, butyl, preferably methyl, or an aryl group, and n is 0, 1, 2 or 3, preferably 0,
   is first reacted with excess ammonia or an organic amine of the general formula (V)

RNH[(CH₂)₂NH]_{z}R (V)
in which R groups are the same or different and R is hydrogen (H) or a linear or branched alkyl group having 1 to 4 carbon atoms, preferably H or n-butyl and z is 0, 1 or 2,
the excess ammonia or unconverted organic amine and any solid salt obtained are removed from the mixture of reaction products thus obtained, it being possible at this point in the process to optimally add a nonpolar organic solvent, preferably toluene, and then
thus obtained product mixture containing ammonium halides and/or amine hydrohalides is subjected to aqueous workup, by
   optionally adding at least one nonpolar organic solvent to the product mixture,
   adding an aqueous alkali,
   allowing them to react,
   separating the aqueous phase from the organic phase, and
   if appropriate removing solvent from the organic phase
   to obtain from the remaining organic phase, at least one amino-functional organosilane of the formula (I)

R₂N[(CH₂)₂NH]_{z}(Z)Si(R″)ₙ(OR′)₃₋ₙ (I)
in which R groups are the same or different and R is hydrogen (H) or a linear or branched alkyl group having 1 to 4 carbon atoms, preferably H or n-butyl, R′ groups are the same or different and R′ is hydrogen (H) or a linear or branched alkyl group having 1 to 8 carbon atoms or an aryl group, preferably methyl or ethyl, R″ groups are the same or different and R″ is a linear or branched alkyl group having 1 to 8 carbon atoms, such as methyl, ethyl, propyl, butyl, preferably methyl, or an aryl group, Z is a bivalent alkyl group from the group of —CH₂—, —(CH₂)₂—, —(CH₂)₃—, —(CH₂)₄— or —(CH₂)(CH)CH₃(CH₂)—, preferably propyl, n is 0, 1, 2 or 3, preferably 0, and z is 0, 1 or 2.

In addition, compounds of the general formulae (II) and/or (III) can likewise be obtained.

In particular, the crude product or product mixture is obtainable when:
A) a halogen-functional organosilane of the general formula (IV)

X—Z—Si(R″)ₙ(OR)₃₋ₙ (IV)
in which X is Cl, Br or I, Z is a bivalent alkyl group from the group of —CH₂—, —(CH₂)₂—, —(CH₂)₃—, —(CH₂)₄— or —(CH₂)(CH)CH₃(CH₂)—, R′ groups are the same or different and R′ is a hydrogen (H) or a linear or branched alkyl group having 1 to 8 carbon atoms or an aryl group, R″ groups are the same or different and R″ is a linear or branched alkyl group having 1 to 8 carbon atoms or an aryl group, and n is 0, 1, 2 or 3,
is reacted with excess ammonia or an organic amine of the general formula (V)

RNH[(CH₂)₂NH]_{z}R (V)
in which R groups are the same or different and R is hydrogen (H) or a linear or branched alkyl group having 1 to 4 carbon atoms, preferably H or n-butyl, and z is 0, 1 or 2,
under pressure, i.e. under standard pressure (atmospheric pressure) or under an elevated pressure, and with a temperature increase, preferably at 1 to 120 bar and 10 to 140° C., in the liquid phase,
B) then excess ammonia or organic amine is removed, preferably distilled, or a phase separation of solid or inorganic and organic phase is performed, to leave ammonium halide or organic amine hydrohalide in each case dissolved fully in the liquid phase,
C) the liquid phase thus obtained is transferred to a crystallizer, optionally with addition of at least one nonpolar organic solvent, preferably toluene, and the crystallizer being operated at a lower pressure level than the preceding reaction stage or at ambient pressure, and ammonium halide or organic amine hydrohalide and crude product are separated,

Subsequently, it is advantageously possible, in a further step, to
D) add optionally at least one nonpolar organic solvent, preferably toluene, to the crude product or product mixture thus obtained, add an aqueous alkali, allow them to react, then separate the aqueous phase from the organic phase, remove any solvent present from the organic phase, preferably by distillation, and
E) filter the organic phase remaining in the bottoms and/or fractionally distill to obtain at least one amino-functional organosilane of the formula (I); in addition it is possible in a simple and economic manner to additionally obtain bis- and tris-aminosilanes of the formulae (II) and/or (III), which are generally obtained as by-products of the aminosilane synthesis.

According to formula (I), preferred compounds are those from the group of 1-aminomethyltrimethoxysilane, 1-aminomethyltriethoxysilane, 1-aminomethylmethyldimethoxysilane, 1-aminomethylmethyldiethoxysilane, 2-amino-ethyltrimethoxysilane, 2-aminoethyltriethoxysilane, 3-aminopropyltrimethoxysilane (AMMO), 3-aminopropyltriethoxysilane (AMEO), 3-aminopropylmethyl-dimethoxysilane, 3-aminopropylmethyldiethoxysilane, N-methyl-3-aminopropyl-trimethoxysilane, N-methyl-3-aminopropyltriethoxysilane, N-butyl-3-aminopropyl-trimethoxysilane, 3-aminopropyldimethylmethoxysilane, 3-aminopropyl-dimethylethoxysilane, 3-aminopropyltrimethylsilane, 3-amino-2-methylpropyl-trimethoxysilane, 3-amino-2-methylpropyltriethoxysilane, N-[2-aminoethyl]-3-amino-propyltrimethoxysilane (DAMO), N-[2-aminoethyl]-3-aminopropyltriethoxysilane, N-[2-aminoethyl]-3-aminopropylmethyldimethoxysilane, N-[2-aminoethyl]-3-aminopropyl-methyldiethoxysilane, N,N-bis[2-aminoethyl]-3-aminopropyltrimethoxysilane, N,N-bis[2-aminoethyl]-3-aminopropyltriethoxysilane, N-[2-aminoethyl]-N′-[2-aminoethyl]-3-aminopropyltrimethoxysilane, N-[2-aminoethyl]-N′-[2-aminoethyl]-3-aminopropyl-triethoxysilane, to name just a few examples.

The halogen-functional organoalkoxysilane of the general formula (IV) used may preferably, but not exclusively, be 3-chloropropyltrimethoxysilane, 3-chloro-propyltriethoxysilane, 3-chloropropylmethyldimethoxysilane or 3-chloropropylmethyl-diethoxysilane. However, it is also possible to use other chloroalkylalkoxysilanes, for example 3-chloropropyldiethylmethoxysilane or 3-chloropropylmethylpropyl-ethoxysilane.

In addition, in the preparation of organoaminoalkyl-functional alkoxysilanes of the general formula (I), instead of the ammonia already mentioned, it is possible to use an organic amine of the general formula (V), for example but not exclusively methylamine, dimethylamine, ethylamine, diethylamine or propylamine.

In said preparation processes for amino-functional organosilanes, residues generally form, i.e. hydrohalides or halogen salts, especially hydrochlorides or chlorides. The procedure can be illustrated by way of example by the following equations:

Cl(CH₂)₃Si(OMe)₃+2NH₃═H₂N(CH₂)₃Si(OMe)₃+[NH₄]⁺Cl⁻

3Cl(CH₂)₃Si(OMe)₃+4NH₃═H₂N(CH₂)₃Si(OMe)₃+[H₂N(CH₂)₃Si(OMe)₃]₂]⁺Cl⁻+2[NH₄]⁺Cl⁻

4Cl(CH₂)₃Si(OMe)₃+5NH₃═H₂N(CH₂)₃Si(OMe)₃+[HN[(CH₂)₃Si(OMe)₃]₃]⁺Cl⁻+3[NH₄]⁺Cl⁻

The residue from the salt removal of the aminosilane preparation process may be present in solid or liquid form and is preferably obtained in a crystallization unit.

The amino-functional organosilane containing ammonium halides and/or amine hydrohalides, especially a corresponding crude product or product mixture, to be worked up in accordance with the invention can, with good mixing, advantageously first, i.e. optionally, be admixed with an essentially nonpolar organic solvent, preferably selected from the group of hexane, heptane, octane, cyclohexane, especially toluene, and/or further nonpolar solvents.

Subsequently, the mixture is treated with an aqueous alkali, preferably a strong alkali having a pH of at least 12, more preferably 13 to 14. The pH can be determined in a manner known per se to those skilled in the art, for example by means of pH paper. The alkali used is preferably an NaOH or KOH solution. The concentration of the aqueous alkali can be selected such that the aqueous phase reaches a pH of 12 after the workup. pH values above 12 are preferable. The volume of the aqueous phase can be determined by the amount of NaCl formed during the workup, and generally depends on the free chloride content of the raw material.

The mixture thus obtained is suitably allowed to react while stirring for up to 30 minutes, preferably 10 seconds to 10 minutes, more preferably 15 seconds to 5 minutes, even more preferably 20 seconds to 3 minutes, especially 25 seconds to 1 minute.

Preference is given to performing the workup at a temperature in the range from 5 to 100° C., more preferably from 10 to 60° C. and especially preferably in the range from 20 to 40° C. Preference is given to working in a heatable/coolable stirred tank with a conically tapering bottom including bottom outlet and viewing window. Tank and stirrer are preferably made from a non-rusting material, for example stainless steel or enameled steel.

In general, two phases form after only a short rest time, which have a sharp separation from one another. After the formation of the two phases, the aqueous phase can be discharged from the organic phase via the bottom valve of the tank, and thus separated from the organic phase.

The aqueous phase generally contains the salt formed in the reaction in dissolved form; for example, in the case of use of sodium hydroxide solution, the aqueous phase thus contains dissolved NaCl. The aqueous phase removed should suitably additionally have a pH of at least 12.

The organic phase can then be transferred into a further separating unit, for example into a distillation, or be conducted through a thin-film evaporator or through a short-path evaporator. The organic solvent, preferably toluene, is removed therein, suitably by removal under reduced pressure.

The organic phase obtainable by the process according to the invention can, however, also be subjected to a fine distillation in order thus to obtain the particular individual constituents of the organic phase obtained in accordance with the invention.

In particular, the process according to the invention can be performed to prepare 1-aminomethyltrimethoxysilane, 1-aminomethyltriethoxysilane, 1-aminomethylmethyldimethoxysilane, 1-aminomethylmethyldiethoxysilane, 2-amino-ethyltrimethoxysilane, 2-aminoethyltriethoxysilane, 3-aminopropyltrimethoxysilane (AMMO), 3-aminopropyltriethoxysilane (AMEO), 3-aminopropylmethyl-dimethoxysilane, 3-aminopropylmethyldiethoxysilane, N-methyl-3-aminopropyl-trimethoxysilane, N-methyl-3-aminopropyltriethoxysilane, N-butyl-3-aminopropyl-trimethoxysilane, 3-aminopropyldimethylmethoxysilane, 3-aminopropyl-dimethylethoxysilane, 3-aminopropyltrimethylsilane, 3-amino-2-methylpropyl-trimethoxysilane, 3-amino-2-methylpropyltriethoxysilane, N-[2-aminoethyl]-3-amino-propyltrimethoxysilane (DAMO), N-[2-aminoethyl]-3-aminopropyltriethoxysilane, N-[2-aminoethyl]-3-aminopropylmethyldimethoxysilane, N-[2-aminoethyl]-3-aminopropyl-methyldiethoxysilane, N,N-bis[2-aminoethyl]-3-aminopropyltrimethoxysilane, N,N-bis[2-aminoethyl]-3-aminopropyltriethoxysilane, N-[2-aminoethyl]-N′-[2-aminoethyl]-3-aminopropyltrimethoxysilane, N-[2-aminoethyl]-N′-[2-aminoethyl]-3-aminopropyl-triethoxysilane, to name just a few examples, and corresponding inventive compositions containing bis- and tris-amino-functional organosilanes, i.e. a composition which contains corresponding bis- and tris-silylated amines of the general formulae (II) and (III).

For the preferred performance of the process steps detailed above, especially steps A to D, reference is additionally made to the contents of EP 1 295 889 A2, EP 1 209 162 A2, DE 101 40 563 A1 and EP 0 849 271 A2. These are fully incorporated in the disclosure of the present application.

In the above-described preferred embodiment of the process according to the invention, it is generally possible to react a halogen-functional organosilane of the general formula (II) with excess ammonia or an organic amine of the general formula (III) under pressure and with a temperature increase in the liquid phase. Subsequently, excess ammonia or organic amine can be removed under pressure, for example by distillation or flashing off, in which case the ammonium halide or organic amine hydrohalide formed suitably remains fully dissolved in the liquid phase. The liquid phase thus obtained can then be transferred into a crystallizer, by initially charging the crystallizer with an organic liquid or organosilicon liquid or a mixture of said liquids, preferably toluene or hexane, heptane, octane, cyclohexane or a mixture thereof, and operating the crystallizer at a lower pressure level than the preceding reaction stage. In general, the residual amounts of ammonia or organic amine are distilled off, optionally additionally by temperature-controlled energy supply. The crystallizer can also be cooled. The salt which contains ammonium halide or organic amine hydrohalide and forms here in the crystallizer can then be removed from the crude product, for example by filtration, and the pure amino-functional organosilane can be obtained from the crude product advantageously by means of aqueous workup. To obtain the pure product, it is additionally possible to perform an optionally fractional distillation, which can be conducted under standard pressure or under reduced pressure. In addition, the residue obtained can likewise be worked up and thus be used to obtain a bis- and tris-amino-functional composition, in a simple and economically viable manner, by adding an essentially nonpolar organic solvent and a strong aqueous alkali to said residue, mixing and allowing to react. Subsequently, the aqueous salt-containing phase can be removed from the organic phase, and the solvent can be removed from the organic phase, preferably under reduced pressure. To obtain a composition containing bis- and tris-amino-functional organosilanes, it is also possible to filter the organic phase remaining in the bottoms (on this subject, see the German parallel application 10 2008 002 183.0 “Method for treating residues containing salt, produced during the production of amino-functional organosilanes”).

Such an aminosilane worked up in a simple and economically viable manner can be used advantageously as an adhesion promoter, as a constituent in coating systems, as a constituent in paints and coating materials, as a drilling aid, as an agent or as an additive in the extraction and conveying of mineral oil, as evident, for example, from WO 05/124100, WO 05/124099, U.S. Pat. No. 4,498,538, U.S. Pat. No. 4,580,633 and US 2004/0177957 A1, as an agent or in an agent for reinforcement or integration of sand-rich soil layers in particular, as a constituent in epoxy resins and phenol resins, as a constituent in plastics, as a constituent in organically modified glasses, for the modification of glass fiber and mineral fiber surfaces, or the glass fiber reinforcement of plastics, as a constituent in sizes and for the treatment of fillers and pigments, and as an additive in adhesives and sealants.

The present invention therefore likewise provides for the use of an aminosilane prepared in accordance with the invention for the aforementioned applications.

The present invention is illustrated in detail by the example which follows, without restricting the subject matter.

### EXAMPLES

### Direct Potentiographic Titration to Determine Hydrolyzable Chloride with Silver Nitrate

Application range: 6-1 000 mg/kg

### Chemicals:

Water: distilled or deionized water
Acetic acid: for analysis, ≧99.8% (glacial acetic acid), shelf life 5 years
Ethanol: denatured, shelf life 10 years
Silver nitrate: 0.1 mol/l, calibration solution, for example ready to use from Merck, shelf life: 2 years, after opening 2 months
Silver nitrate: 0.01 mol/l or 0.005 mol/l, calibration solution, is prepared by diluting the solution from 6.4, shelf life 2 months
Sodium chloride: 0.01 mol/l, calibration solution: shelf life: 6 months Preparation of the Calibration Solution from an ampoule, e.g. Titrisol7 from Merck with c(NaCl)=0.1 mol/l

### Instruments and Software:

150 ml beakers, tall form
10 ml, 25 ml and 100 ml measuring cylinders
Automatic titrator: e.g. Metrohm 682 with silver rod electrode and Ag/AgCl reference electrode
Magnetic stirrer and _eflon-sheathed stirrer bar

### Procedure:

The appropriate amount of sample is placed into a 150 ml beaker and admixed with 20 ml of ethanol and 80 ml of acetic acid. This is followed by potentiographic titration with silver nitrate solution. The same amount of reagent is used to determine a blank value.

### Evaluation:

The titroprocessor is generally programmed such that the proportion by mass of chloride in mg/kg is expressed directly after the titration.
For this and for the manual evaluation, the following formula applies:

$$\frac{( {V}_{T} - {V}_{BI} ) \times {C}_{AgNO 3} \times 35.5 \times 1000}{E} = mg {Cl}^{-} \text{/} kg$$

V_{T}=Consumption of AgNO₃ solution in ml
V_{BI}=Blank value determined of AgNO₃ solution in ml
c_{AgNO3}=Concentration of the AgNO₃ solution in mol/l
35.5=Molar mass of chloride in g/mol
1000=Conversion factor in g/kg
E=Starting weight in g

### Example 1

### Preparation of 3-(n-butylamino)propyltrimethoxysilane

328.95 g of n-butylamine were initially charged in a 1 l Büchi glass autoclave. At a temperature of 130° C. and a pressure of 3.2 bar, 298.5 g of CPTMO were metered in by means of a pump (5 ml/min). After the metered addition had been ended, the reaction was held at 155° C. for 2 h, then cooled to 140° C. After the reactor had been decompressed, the n-butylamine was removed by distillation at 145° C. The crystal slurry was admixed with 1295 g of toluene and transferred while warm to a separating funnel. Then a cold aqueous solution (113.2 g of NaOH and 329 g of H₂O) was added and the mixture was stirred vigorously for 30 s. The subsequent phase separation took 30 s.

Weight of aqueous phase: 497 g
Weight of organ. phase: 1609 g

The organic phase was freed of the toluene on a rotary evaporator at 89 to 95 mbar and 57 to 65° C. Subsequently, the product was distilled at 3 mbar and 126° C.

1st fraction (toluene): 1217 g
2nd fraction (product): 271.9 g, clear colorless liquid
Yield: 72%

1. A process for working up an amino-functional organosilane comprising at least one ammonium halide and/or organic amine hydrohalide, the process comprising:
optionally, adding at least one nonpolar organic solvent to a mixture of the amino-functional organosilane comprising the at least one ammonium halide and/or organic amine hydrohalide,
adding an aqueous alkali,
reacting the aqueous alkali and the mixture;
then separating a resulting aqueous phase from a resulting organic phase; and
removing any solvent present from the organic phase, to obtain a remaining organic phase.

2. A process, comprising
A) reacting a halogen-functional organosilane of formula (IV)
X—Z—Si(R″)ₙ(OR′)₃₋ₙ (IV),
wherein
X is Cl, Br or I,
Z is a bivalent alkyl group from the group of —CH₂—, —(CH₂)₂—, —(CH₂)₃—, —(CH₂)₄—, or —(CH₂)(CH)CH₃(CH₂)—,
R′ groups are the same or different and R′ is a hydrogen or a linear or branched alkyl group having 1 to 8 carbon atoms or an aryl group,
R″ groups are the same or different and R″ is a linear or branched alkyl group having 1 to 8 carbon atoms or an aryl group, and
n is 0, 1, 2 or 3,
with excess ammonia or an organic amine of formula (V)
RNH[(CH₂)₂NH]_{z}R (V)
wherein R groups are the same or different and R is hydrogen or a linear or branched alkyl group having 1 to 4 carbon atoms, and z is 0, 1, or 2,
to obtain a first product mixture,
B) removing the excess ammonia or unconverted organic amine and any solid salt obtained from the first product mixture optionally with addition of at least one nonpolar organic solvent,
to obtain a second product mixture, and then
C) subjecting the second product mixture, comprising at least one ammonium halide and/or organic amine hydrohalide, to aqueous workup, by
c1) optionally adding at least one nonpolar organic solvent,
c2) adding an aqueous alkali to obtain a third product mixture,
c3) allowing the third product mixture to react,
c4) separating a resulting aqueous phase from a resulting organic phase, and
c5) if present, removing solvent from the organic phase to obtain, from a remaining organic phase, at least one amino-functional organosilane of formula (I)
R₂N[(CH₂)₂NH]_{z}(Z)Si(R″)ₙ(OR′)₃₋ₙ (I),
wherein
R groups are the same or different and R is hydrogen or a linear or branched alkyl group having 1 to 4 carbon atoms,
R′ groups are the same or different and R′ is hydrogen or a linear or branched alkyl group having 1 to 8 carbon atoms or an aryl group,
R″ groups are the same or different and R″ is a linear or branched alkyl group having 1 to 8 carbon atoms or an aryl group,
Z is a bivalent alkyl group from the group of —CH₂—, —(CH₂)₂—, —(CH₂)₃—, —(CH₂)₄—, or —(CH₂)(CH)CH₃(CH₂)—,
n is 0, 1, 2, or 3, and
z is 0, 1 or 2.

3. The process according to claim 2,
wherein,
a nonpolar organic solvent is added to the second product mixture while stirring in the optionally adding c1), a strong aqueous alkali is additionally added in the adding c2), and the mixture is allowed to react with good mixing for 10 seconds to 30 minutes in the allowing c3) to subsequently form two phases.

4. The process according to claim 1, wherein the nonpolar organic solvent is present and is toluene.

5. The process according to claim 1, wherein the aqueous alkali is a sodium hydroxide solution or potassium hydroxide solution.

6. The process according to claim 1, wherein the aqueous alkali is an aqueous alkali with a pH of 12 to 14.

7. The process according to claim 1, wherein, after the adding the aqueous alkali, the mixture is allowed to react at a temperature in a range from 5 to 100° C.

8. The process according to claim 1, wherein, in the removing, the solvent present from the organic phase is distilled out of the organic phase under atmospheric pressure or reduced pressure.

9. The process according to claim 1, wherein, the organic phase remaining after the separating is filtered.

10. A process, comprising
A) reacting a halogen-functional organosilane of formula (IV)
X—Z—Si(R″)ₙ(OR′)₃₋ₙ (IV),
wherein
X is Cl, Br or I,
Z is a bivalent alkyl group from the group of —CH₂—, —(CH₂)₂—, —(CH₂)₃—, —(CH₂)₄—, or —(CH₂)(CH)CH₃(CH₂)—,
R′ groups are the same or different and R′ is a hydrogen or a linear or branched alkyl group having 1 to 8 carbon atoms or an aryl group,
R″ groups are the same or different and R″ is a linear or branched alkyl group having 1 to 8 carbon atoms or an aryl group, and
n is 0, 1, 2 or 3,
with excess ammonia or an organic amine of formula (V)
RNH[(CH₂)₂NH]_{z}R (V),
wherein R groups are the same or different and R is hydrogen or a linear or branched alkyl group having 1 to 4 carbon atoms, and z is 0, 1 or 2, under pressure and with a temperature increase in a liquid phase,
B) then removing excess ammonia or organic amine to leave ammonium halide or organic amine hydrohalide dissolved fully in the liquid phase,
C) transferring the liquid phase obtained in B) to a crystallizer,
optionally with addition of at least one nonpolar organic solvent and the crystallizer being operated at a lower pressure level than the preceding reaction stage or at atmospheric pressure, and separating ammonium halide or organic amine hydrohalide from a crude product,
D) optionally, adding at least one nonpolar organic solvent to the crude product or product mixture obtained in C), adding an aqueous alkali, and allowing the aqueous alkali and the crude product or product mixture to react, then separating a resulting aqueous phase from a resulting organic phase, removing solvent from the resulting organic phase which has been separated, and
E) filtering and/or distilling the organic phase remaining in the bottoms to obtain at least one aminofunctional organosilane according to formula (I)
R₂N[(CH₂)₂NH]_{z}(Z)Si(R″)ₙ(OR′)₃₋ₙ (I),
wherein
R groups are the same or different and R is hydrogen or a linear or branched alkyl group having 1 to 4 carbon atoms,
R′ groups are the same or different and R′ is hydrogen or a linear or branched alkyl group having 1 to 8 carbon atoms or an aryl group,
R″ groups are the same or different and R″ is a linear or branched alkyl group having 1 to 8 carbon atoms or an aryl group,
Z is a bivalent alkyl group from the group of —CH₂—, —(CH₂)₂—, —(CH₂)₃—, —(CH₂)₄—, or —(CH₂)(CH)CH₃(CH₂)—,
n is 0, 1, 2 or 3, and
z is 0, 1 or 2.

11. The process according to claim 2, wherein the nonpolar organic solvent is present and is toluene.

12. The process according to claim 2, wherein the aqueous alkali is a sodium hydroxide solution or potassium hydroxide solution.

13. The process according to claim 2, wherein the aqueous alkali is an aqueous alkali with a pH of 12 to 14.

14. The process according to claim 2, wherein, after the adding the aqueous alkali, the mixture is allowed to react at a temperature in a range from 5 to 100° C.

15. The process according to claim 2, wherein, in the removing, the solvent present from the organic phase is distilled out of the organic phase under atmospheric pressure or reduced pressure.

16. A process according to claim 2, wherein, the organic phase remaining after the separating is filtered.

17. The process according to claim 10, wherein the nonpolar organic solvent is present and is toluene.

18. The process according to claim 10, wherein the aqueous alkali is a sodium hydroxide solution or potassium hydroxide solution.

19. The process according to claim 10, wherein the aqueous alkali is an aqueous alkali with a pH of 12 to 14.

20. The process according to claim 10, wherein, after the adding the aqueous alkali, the mixture is allowed to react at a temperature in a range from 5 to 100° C.
